(19) United States
(12) Patent Application Publication
(10) Pub. No.: US 2013/0085884 A1
(43) Pub. Date: Apr. 4, 2013

(54) BUYER/SUPPLIER NETWORK COLLABORATION AND BIDS POLICY

(71) Applicants: Cathal O'Sullivan, Chicago, IL (US); Raghavendra Keshavamurthy, Bangalore (IN); Anwar Nadaf, Bangalore (IN); Bhaskar Himatsingka, Sunnyvale, CA (US)

(72) Inventors: Cathal O'Sullivan, Chicago, IL (US); Raghavendra Keshavamurthy, Bangalore (IN); Anwar Nadaf, Bangalore (IN); Bhaskar Himatsingka, Sunnyvale, CA (US)

(73) Assignee: ARIBA, INC., Sunnyvale, CA (US)

(21) Appl. No.: 13/249,936

(22) Filed: Sep. 30, 2011

(51) Int. Cl. G06Q 30/06; G06Q 30/08

(52) U.S. Cl. 705/26.4

(57) ABSTRACT

Embodiments of method, systems and apparatuses for dynamic collaboration of a buyer/supplier network are disclosed. One method includes providing a buyer with a catalog or non-catalog item. A collaboration request is submitted by the buyer, thereby initiating a negotiation with one or more suppliers. The collaboration request is provided to the one or more suppliers. A proposal is received from at least one of the suppliers, and the buyer provides an acceptance or a rejection to each received proposal. An embodiment further specifies that the buyer collaborate with at least N suppliers, wherein N is selected by the buyer.

### FIELD OF THE DESCRIBED EMBODIMENTS

The described embodiments relate generally to a supplier/buyer commerce network. More particularly, the described embodiments relate to a methods, apparatuses and systems for a supplier/buyer commerce network that aids a collaboration and bids policy between a buyer and at least one supplier.

### BACKGROUND

Some supplier networks include a transaction routing hub that connects one or more suppliers and one or more buyers. As an example of how a supplier network is used, in some cases a given buyer enters or provides purchase information electronically and the purchase information is routed or otherwise sent to a given supplier. This may, for example, enable a buyer to make purchases in a completely paperless manner.

Ideally, the supplier network enables buyers to negotiate favorable rates on purchased good and/or services. Additionally, the supplier network should encourage suppliers to participate with the supplier network, thereby expanding the reach of the supplier network.

There is a need for systems, methods and apparatuses for providing and encouraging collaboration between buyers and multiple suppliers of commerce networks. Additionally, it is desirable that the commerce networks adhere to policies set by buyers of the network.

### SUMMARY

An embodiment includes a computer-method of dynamic collaboration of a buyer/supplier network. The method includes providing a buyer with a catalog or non-catalog item. A collaboration request is submitted by the buyer, thereby initiating a negotiation with one or more suppliers. The collaboration request is provided to the one or more suppliers. A proposal is received from at least one of the suppliers, an acceptance or a rejection to each received proposal is received. An embodiment further specifies that the buyer collaborate with at least N suppliers, wherein N is selected by the buyer.

An embodiment includes a computer-method of dynamic collaboration of a buyer/supplier network. The method includes providing a buyer with a catalog or non-catalog item. The buyer submits a collaboration request, thereby initiating a negotiation with one or more suppliers. The collaboration request is provided to a minimum number of suppliers. Proposals are received from at the minimum number of the suppliers, and the buyer accepts or rejects each received bid.

Another embodiment includes buyer/supplier commerce network. The buyer/supplier commerce network includes a buyer/supplier server operative to provide a buyer with a catalog or non-catalog item. The buyer server is operative to submit a collaboration request, thereby initiating a negotiation with one or more suppliers. Further, the buyer/supplier server is operative to provide the collaboration request to the one or more suppliers. Further, the buyer/supplier server is operative to receive a proposal from at least one of the suppliers, and operative to receive acceptances or rejections from the buyer for each received proposals.

Another embodiment includes a program storage device readable by a machine, tangibly embodying a program of instructions executable by the machine to perform a computer-method of facilitating collaboration between a buyer and suppliers, and implementing a bids policy. When executed, the computer-method provides a buyer with a catalog or non-catalog item, receives, a collaboration request submitted by the buyer, thereby initiating a negotiation with one or more suppliers. The collaboration request is provided to the one or more suppliers, and a proposal is received from at least one of the suppliers. The buyer then acceptance or a rejects each received proposal.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example a supplier/buyer commerce network that facilitates collaboration between a buyer and suppliers, and implements a bids policy.

FIG. 2 is a flow chart that includes steps of an example of a computer-method of a buyer/supplier network aiding supplier enablement through creation of a requisition between a buyer and a supplier.

FIG. 3 shows a schematic illustration of one embodiment of a computer system that can perform the methods of the described embodiment, and/or can function as, for example, a supplier/buyer commerce network that facilitates collaboration between a buyer and suppliers, and implements a bids policy.

### DETAILED DESCRIPTION

The embodiments described include methods, systems and apparatuses for a supplier/buyer commerce network that provides for collaboration between a buyer and multiple suppliers. Additionally, some embodiments additionally include a bid policy that includes at least N suppliers submitting proposals, and the buyer receiving N bids. The number of bids is adaptable, one embodiment including a minimum number of bids being received by the buyer, wherein the minimum number of bids is selectable by the buyer.

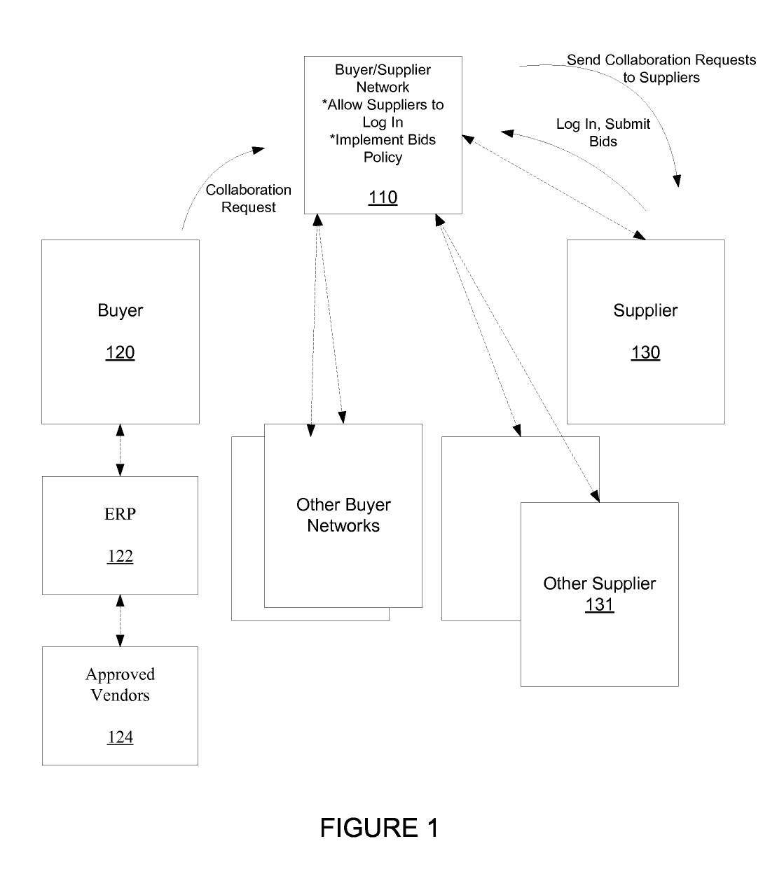

FIG. 1 shows an example of a system that facilitates a supplier/buyer commerce network 110 electronically introducing a buyer 120 to suppliers 130, 131. The buyer 120 is generally associated with the supplier/buyer commerce network 110 in some capacity. However, the suppliers 130, 131 can be either associated (enabled) or not associated (not enabled) with the supplier/buyer commerce network 110. Generally, a supplier 130, 131 is enabled once the supplier has joined the supplier/buyer commerce network. While a single buyer is described, it is to be understood that typically many buyers (such as other buyer of FIG. 1) are associated with the supplier/buyer commerce network 110.

The supplier/buyer commerce network 110 includes one or more servers, wherein each server includes at least one processor. The servers of the supplier/buyer commerce network 110 are interfaced through a network to the buyer 120 and the suppliers 130, 131. That is, the supplier/buyer commerce network 110 interacts (receives and transmits information) with the buyer 120 and the suppliers 130 through the network that is interfaced with the supplier/buyer commerce network 110.

The buyer 120 utilizes an enterprise procurement system (generally, a software application) that operates on a server (that includes one or more processors) which is typically a part of a buyer enterprise network. Therefore, the reference to a buyer 120 assumes the buyer is operating on a buyer server within an enterprise (buyer) network. The buyer network communicates through previously described network and network connections (interfaces) with the supplier/buyer commerce network 110.

The suppliers 130, 131 typically include a supplier networks (that include enterprise servers, wherein the enterprise servers include processors) that access the supplier/buyer commerce network 110. As will be described, in some embodiments the suppliers 130, 131 can “punch through” and directly provide information to, for example, the enterprise procurement system of the buyer 120. Suppliers are only allowed to punch through the supplier/buyer commerce network 110 if they have been enabled. The supplier network(s) communicate through the previously described network and network connections (interfaces) with the supplier/buyer commerce network 110.

For embodiments, the enterprise procurement system of the buyer 120 hosts supplier catalogs for purchasing. The hosted catalogs can include catalogs of both suppliers that are associated (enabled) with the supplier/buyer commerce network 110 and/or suppliers that are buyer approved but not necessarily associated (enabled) with the supplier/buyer commerce network 110. Additionally, embodiments of the enterprise procurement system can support defined purchasing policies, and manage purchasing approvals by buyer entities.

Embodiments also allow the buyer to submit collaboration requests of non-catalog items. A non-catalog item is an item that has not been predefined as a standard catalog item. Therefore, the buyer may not have access or know a pricing or quantity information of the item. The inclusion of non-catalog items provides greater flexibility to the buyers. That is, collaboration request submitted by the buyer is not limited to the items that are cataloged, thereby expanding the goods and services available to the buyer for collaboration.

The buyer 120 can submit collaboration requests to suppliers. Generally, the collaboration request includes proposed purchase terms for an item, whether the item is within a catalog or not. The collaboration request can include purchase terms, such as, rates, quantity, availability or other specifications.

For embodiments, a set of suppliers are selected that are likely candidates to be able to provide with the good or service being pursued by the buyer. The good or service desired by the buyer 120 is known by the enterprise procurement system of the buyer 120, and the buyer/supplier network 110. For one embodiment, the suppliers are pre-approved by the buyer. That is, for example, the suppliers are part of, a buyer's vendor master which is a list of approved buyer vendors. Based on knowledge of the product or service, and knowledge of the suppliers of the approved list, an appropriate set of suppliers can be logically selected.

For an embodiment, the buyer's approved list includes suppliers that are associated (enabled) with the supplier/buyer commerce network 110. In this situation, the buyer 120 have generally already have transacted business with the suppliers that are chosen for the collaboration request. For another embodiment, the buyer's approved list includes suppliers that are not associated (not enabled) with the supplier/buyer commerce network 110. In this situation, the buyer 120 may not have previously transacted business with these not previously enabled suppliers, and have not previously transacted with these suppliers using the supplier/buyer commerce network 110.

Embodiments include creating an account for suppliers if accounts do not already exist, and sending collaboration requests to the set of suppliers. Generally, creating an account includes assigning a supplier a unique identification (ID) in the buyer/supplier network 110. For an embodiment, the collaboration requests are sent (for example, email) that includes a URL to log into the buyer/supplier network 110.

Sending invitation includes, for example, electronically communicating the collaboration request to the set of suppliers. This can include, for example, emailing or faxing the collaboration request to the set of suppliers. The electronic addresses of the suppliers can be received from the buyer or from the supplier profile.

Once the set of suppliers have electronically received collaboration requests, the invited suppliers can log into the supplier/buyer commerce network 110 through the invitation, and submit a proposal in response to the collaboration request. The collaboration request invitations can be sent, for example, as an email that includes a link to a website of the supplier/buyer commerce network 110. For an embodiment, the supplier is enabled when the supplier logs into the account created on the supplier/buyer commerce network 110. The set of suppliers can address collaboration requests (submit a proposal) of the buyer after logging in to the supplier/buyer commerce network 110. The log-in procedure can be managed directly by the supplier/buyer commerce network 110. The buyer then logs into the buyer network 120.

Once logged in, for an embodiment, supplier/buyer commerce network 110 facilitates a punch in to the buyer 120, wherein the supplier can submit the proposal, on for example, enterprise procurement system of the buyer 120. The proposals of multiple suppliers are then accessible by the buyer as bids that can be accessed by the buyer within the enterprise procurement system of the buyer 120.

Embodiments further include a minimum of N bids policy. That is, the collaboration requests are sent to at least a minimum number of suppliers, and at least the minimum number N of suppliers must submit proposals in response to the collaboration requests. For embodiments, the minimum number of bids N is dependent upon a requisition amount, a purchasing unit, a company code, and/or a commodity code (common commodity code, a partitioned commodity code).

An embodiment includes a hard stop wherein N proposals must be received in order for collaboration to continue. That is, if N proposals are not received, the collaboration is halted. Another embodiment includes a soft stop, wherein collaboration can continue in some form even if N proposals are not received.

For embodiments, the minimum number of required proposals is selected by the buyer, or more specifically, a buyer policy. For an embodiment, a policy table maintains the buyer selected minimum number of required proposals.

In order for a supplier to respond to the collaboration requests, the supplier must be associated with the buyer/supplier network. That is, the supplier must be enabled. For an embodiment, the supplier is received through the collaboration request initiated by the buyer, and was submitted as an approved vendor of the buyer. Therefore, the buyer/supplier network assumes the buyer has approved of the supplier, and therefore, the supplier is enabled for future transactions with the buyer through the buyer/supplier network 110. The future transactions can include, for example, the completion of a purchase order between the buyer the least one suppliers. More specifically, completion of a purchase order that was generated by collaboration between the buyer and the supplier.

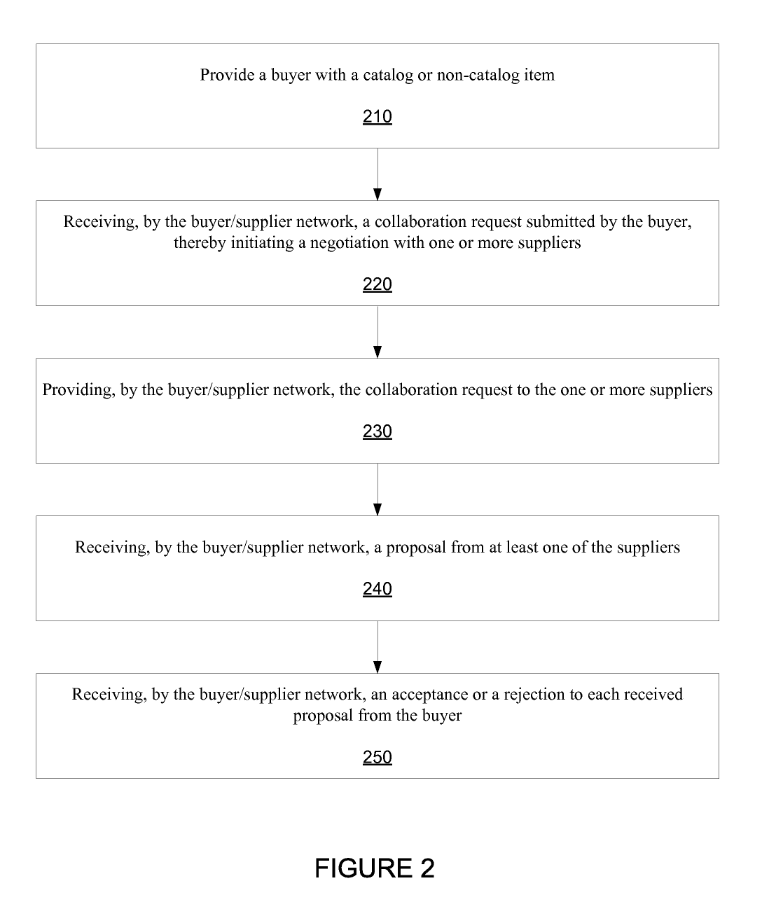

FIG. 2 is a flow chart that includes steps of an example of a computer-method of a buyer/supplier network collaboration and bids policy. A first step 210 includes providing a buyer with a catalog or non-catalog item. A second step 220 includes receiving, by the buyer/supplier network, a collaboration request submitted by the buyer, thereby initiating a negotiation with one or more suppliers. A third step 230 includes providing, by the buyer/supplier network, the collaboration request to the one or more suppliers. A fourth step 240 includes receiving, by the buyer/supplier network, a proposal from at least one of the suppliers. A fifth step 250 includes receiving, by the buyer/supplier network, an acceptance or a rejection to each received proposal from the buyer.

The buyer/supplier network and the computer-methods of the buyer/supplier network are operable on, for example, a buyer/supplier server, wherein the buyer/supplier server can include one or more networked servers. The buyer interfaces with the buyer/supplier network through one or more buyer enterprise network servers of a buyer network. The buyer enterprise network servers and the buyer network are network interfaced to the buyer/supplier network. Further, the suppliers interface with the buyer/supplier network through one or more supplier enterprise network servers of supplier networks. The supplier enterprise network servers and the supplier networks are network interfaced to the buyer/supplier network.

As previously mentioned, the catalog items are accessible by the buyer through, for example, hosted catalogs of the buyer's enterprise procurement system. Embodiments of the enterprise procurement system operate on a buyer server within a buyer network that interfaces with the buyer/supplier network. Non-catalog items are items that are not predefined as a standard catalog item. Therefore, the buyer may not have access or know a pricing or quantity information of the item.

Base on the catalog or non-catalog item, the buyer submits a collaboration request to start negotiations. The collaboration request can include, for example, proposed quantities, terms, and prices for a good or service.

The collaboration request is then provided to a minimum number of suppliers. Buyer policies can include policies requiring a minimum number of bids to be received by the buyer before completing a purchase. The buyer policy can be incorporated in the collaboration between the buyer and suppliers, by requiring the collaboration request to be provided to at least the minimum number of suppliers, and requiring the buyer to receive at least the minimum number of proposals from the suppliers.

Many suppliers can be associated (enabled) with the buyer/supplier network. Additional suppliers can be approved vendors of the buyer, but not be associated with the buyer/supplier network. Somehow the list of possible suppliers needs to be evaluated to determine which suppliers are to receive the collaboration request. For an embodiment, the list of suppliers to receive the collaboration request can be identified by the buyer. For other embodiments, the buyer/supplier network can select the list of suppliers based, for example, on the goods and services provided by the supplier, and/or a location of the supplier.

Embodiments further include the buyer collaborating with at least N suppliers. The buyer then receives N bids (proposals) from the suppliers. For an embodiment, the minimum number of proposals to be received is determined by, for example, a policy of the buyer. One embodiment includes a hard stop policy wherein collaboration is not allowed to continue if the predefined number of bids (proposals) is not received from the suppliers. Another embodiment includes a soft stop policy, wherein the collaboration is allowed to continue even if the required number of bids (proposals) is not received. For the soft stop nothing changes except that the buyer can continue with collaboration or even end collaboration without N proposals.

Further, the buyer then accepts or rejects each of the at least N bids. Another embodiment includes the buyer accepting a proposal and proactively halting collaboration. This embodiment further includes the buyer/supplier network automatically rejecting the rest of the proposals.

For an embodiment, N is dependent on a requisition amount of the good or service the buyer desires, the purchasing unit, a company code of the good or service, and/or the commodity code (for example, a common commodity code or a partitioned commodity code) of the good or service.

For embodiments, the value of N is adaptively selected by the buyer. For an embodiment, N is minimum number of proposals required for collaboration, and N is accessed from a policy look up table of the buyer. Attributes of the policy table can be configured by the buyer including the value of N. Additionally, the policy table includes data related to fields of a buyer policy, terms of the buyer policy.

For embodiments, at least one of the suppliers is not registered with the buyer/supplier network. That is, theses supplier are not enabled to transact with the buyer. For one embodiment, the buyer has an enterprise resource planning (ERP) system that includes at least one approved vendors. Suppliers that are not registered with the buyer/supplier network can include approved vendors from the ERP system of the buyer.

Non-registered suppliers can be activated (enabled) after responding to an invitation to collaborate. Once activated, an embodiment includes establishing a connection on the buyer/supplier network between the buyer and the suppliers who have responded to the collaboration request. Once activated, the suppliers can push information to the buyer.

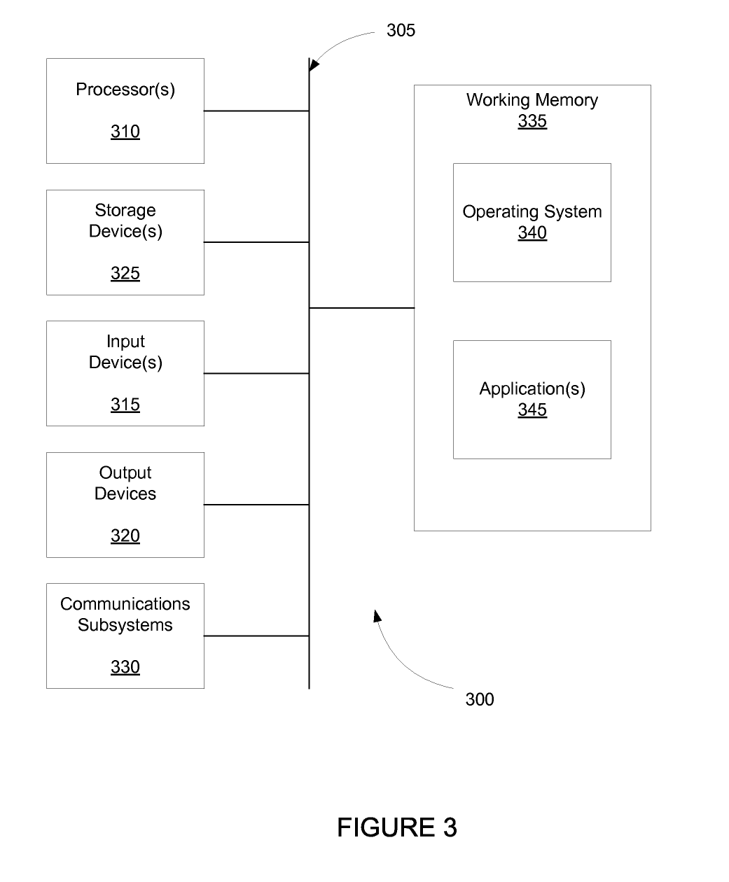

FIG. 3 shows a schematic illustration of one embodiment of a computer system that can perform the methods of the described embodiment, and/or can function as, for example, a supplier/buyer commerce network that facilitates collaboration between a buyer and suppliers, and implements a bids policy. It should be noted that FIG. 3 is meant only to provide a generalized illustration of various components, any or all of which may be utilized as appropriate. FIG. 3, therefore, broadly illustrates how individual system elements may be implemented in a relatively separated or relatively more integrated manner.

The computer system 300 is shown comprising hardware elements that can be electrically coupled via a bus 305 (or may otherwise be in communication, as appropriate). The hardware elements can include one or more processors 310, communication subsystems 330, one or more input devices 315, which can include without limitation a mouse, a keyboard and/or the like; and one or more output devices 320, which can include without limitation a display device, a printer and/or the like. The computer system 300 may further include (and/or be in communication with) one or more storage devices 325. The computer system 300 also can comprise software elements, shown as being located within the working memory 335, including an operating system 340 and/or other code, such as one or more application programs 345, which may comprise computer programs of the described embodiments for the computer-method of dynamic collaboration of a buyer/supplier network, and/or may be designed to implement methods of the described embodiments and/or configure systems of the embodiments as described herein.

At least some embodiments include a program storage device readable by a machine (of the supplier/buyer commerce network), tangibly embodying a program of instructions executable by the machine to perform a computer-method of facilitating collaboration between a buyer and suppliers, and implementing a bids policy. The computer-method performed includes providing a buyer with a catalog or non-catalog item, receiving, by the buyer/supplier network, a collaboration request submitted by the buyer, thereby initiating a negotiation with one or more suppliers, providing, by the buyer/supplier network, the collaboration request to the one or more suppliers, receiving, by the buyer/supplier network, a proposal from at least one of the suppliers, and receiving, by the buyer/supplier network, an acceptance or a rejection to each received proposal. Another computer-method includes receiving, by the buyer/supplier network, a collaboration request submitted by a buyer, thereby initiating a negotiation with one or more suppliers, providing, by the buyer/supplier network, the collaboration request to the at least N suppliers, receiving, by the buyer/supplier network, a proposal from at least N of the suppliers, wherein if at least N proposals are not received, then halting the collaboration, and receiving, by the buyer/supplier network, an acceptance or a rejection to each received proposal, wherein N is adaptively selected by the buyer.

Alternate and Additional Embodiments

Referencing FIG. 1, for an embodiment, the collaboration request includes a set of approved and/or not approved vendors of the buyer. The approved list can be obtained, for example, from an approved list of vendors 124 associated with an Enterprise Resource Planning (ERP) network 122. For many businesses ERP applications include complex information systems that support and automate business processes such as human resources, manufacturing, distribution, project management, payroll, and/or financials. A non-approved list can be obtained, for example, from a third party that has information of providers of the good or service that the buyer is attempting to purchase.

For embodiments, the list is narrowed to a select set of suppliers that are likely candidates to collaborate with the buyer in the purchase of the good or service being pursued by the buyer who should receive the collaboration requests. The good or service desired by the buyer of the buyer network 120 is known by the buyer/supplier network 110. Based on knowledge of the product or service, and knowledge of the suppliers of the list, and appropriate set of suppliers can be logically selected.

Embodiments include both the list of suppliers being derived from supplier profiles managed by the buyer/supplier network 110 and the approved suppliers from buyer network 120. Products, locations and other parameters of the supplier profile can be used to rank the probability that the suppliers will be able to collaborate with the buyer in the buyer's purchase of the good or service. The top ranked, or suppliers having a selected rank or better can be selected as the select set of suppliers that receive invitations.

The supplier profile can include at least one of self-reported information, community information third party information, and/or aggregated activity information. Generally, supplier profile includes a collection of information pertaining to the corresponding company that is associated with the network.

The self-reported information includes company provided information that can be received by the buyer/supplier network and incorporated into the company profile. The self-reported information can be received in different ways. For example, a company may effectively “walk up” and join the supplier/buyer commerce network, or the company information can be loaded by the buyer/supplier network 110 or from another database or application. The self-reported information can include both public information, as well as private information (for example, credit card and/or personal information). For an embodiment, the public information becomes a part of the profile.

For embodiments, pieces of the self-reported information are used to drive additional processes in the supplier/buyer commerce network. That is, for example the self-reported information can include a DUNS number field. Once the supplier/buyer commerce network has the DUNS number, the supplier/buyer commerce network can provide financial risk score information on the supplier. The DUNS number can be used to drive communication with, for example, a third party. Additionally, a matching process can be utilized to analyze commodities (goods & services) a supplier has selected as providing, and the sales territories of the supplier, in order to match that supplier's profile against the business opportunities.

The community information includes information that pertains to the company that is provided by supplier networks 130, 131 and buyer networks (such as, buyer network 120) associated with the network. The community information includes, for example, ratings. The ratings allow, for example, a buyer to rate any supplier that has responded to a business opportunity on the supplier/buyer commerce network 110.

Another aspect of the community information includes references. For example, a supplier may request a buyer to leave a reference for the supplier. For embodiments, the supplier solicits the reference by supplying the email address of the buyer, or otherwise identifies the buyer. To further facilitate community and parallel real world interactions, embodiments of the supplier/buyer commerce network allows other buyers to request contact with the author of any given reference. For embodiments, the subject of the reference (the supplier) is the gatekeeper in such an interaction and may decline or accept the third party's request to speak with a reference. For embodiments, the reference itself contains a few pieces of information, for example, a text narrative, industry of the buyer, and/or length of the business relationship.

The third party information includes information that pertains to the company that is provided by a third party who is typically not associated directly with the network. The third party information includes, for example, a business and credit rating provided by, for example, an established rating agency (such as, Dun & Bradstreet® (D&B)). The third party information can include financial risk information about suppliers. This can be provided, for example, using self-reported DUNS number information. The DUNS information can be validated with D&B using an API call. The validated information can be displayed back to the supplier for their approval. Once approved, the supplier/buyer commerce network basically has the supplier linked to a risk profile on D&B.

The aggregated activity information includes, for example, transactional activity of the company. The aggregated activity information includes information about suppliers and their performance on the supplier/buyer commerce network 110.

A useful piece of aggregated activity information included within the company profile is the number of transacting relationships that the company has with buyers/suppliers of buyer/supplier networks on the supplier/buyer commerce network 110, and/or transacting relationships the company has with buyers/suppliers of other commerce networks, such as cloud networks. This information provides a valuable picture of how many other companies the company is actively doing business with via the supplier/buyer commerce network 110, and the cloud networks. It is to be understood that doing business with other companies includes activities can include interactions that do not include money, good or services changing hands. If the supplier/buyer commerce network 110 is interfaced with cloud networks, the company profile can be made to be common (the same) between commerce network platforms. Therefore, real-time information can be utilized across the supplier/buyer commerce network 110 and external cloud network platforms.

Examples of aggregated activity information include, but are not limited to, event invitations, invitations by revenue, transaction awards (for example, winning supplier bids), revenue ranges, and/or top bids by industry.

Embodiments include creating an account, and sending invitations to the set of suppliers. Generally, creating an account includes assigning a supplier a unique identification (ID) in the buyer/supplier network 110. For an embodiment, the invitations are sent (for example, email) that includes a URL to log into the buyer/supplier network 110.

Sending invitation includes, for example, electronically communicating the collaboration request to the set of suppliers. This can include, for example, emailing the collaboration request to the set of suppliers. Additionally, or alternatively, the electronic communication can be made to the set suppliers by, faxing, phoning, tweeting, or through a small message system (sms). The electronic addresses of the suppliers can be received from the buyer or from the supplier profile.

Once the set of suppliers have electronically received invitations, the invited suppliers can log into the buyer/supplier network 110 through the invitation, and address the request for information. The invitations can be sent, for example, as an email that includes a link to a website of the buyer/supplier network 110. For an embodiment, the supplier is enabled when the supplier logs into the account created on the buyer/supplier network 110. The set of suppliers can collaborate with the seller in the purchase of the complex good or service after logging in to the buyer/supplier network 110. The log-in procedure can be managed directly by the buyer/supplier network 110, but can additionally or alternatively be managed by a procurement engine. The buyer then logs into the buyer/supplier network 110 or the procurement engine to obtain the information provided by the enabled suppliers.

Although specific embodiments have been described and illustrated, the embodiments are not to be limited to the specific forms or arrangements of parts so described and illustrated.

What is claimed:

1. A computer-method of dynamic collaboration of a buyer/supplier network, comprising:
providing a buyer with a catalog or non-catalog item;
receiving, by the buyer/supplier network, a collaboration request submitted by the buyer, thereby initiating a negotiation with one or more suppliers;
providing, by the buyer/supplier network, the collaboration request to the one or more suppliers;
receiving, by the buyer/supplier network, a proposal from at least one of the suppliers; and
receiving, by the buyer/supplier network, an acceptance or a rejection to each received proposal from the buyer.

2. The computer-method of claim 1, further comprising:
the buyer collaborating with at least N suppliers; and
the buyer receiving at least N proposals from the suppliers.

3. The computer-method of claim 2, further comprising collaborating, by the buyer, the purchase of a service.

4. The computer-method of claim 2, wherein if proposals are not received from at least N suppliers, the collaboration is halted.

5. The computer-method of claim 2, further comprising the buyer accepting or rejecting each of the at least N bids.

6. The computer-method of claim 2, wherein N is dependent on a requisition amount.

7. The computer-method of claim 2, wherein N is dependent on a purchasing unit.

8. The computer-method of claim 2, wherein the N is dependent on a company code.

9. The computer-method of claim 2, wherein N is dependent on a commodity code (common commodity code, a partitioned commodity code).

10. The computer-method of claim 2, wherein N is minimum number of proposals required for collaboration, and N is accessed from a policy look up table of the buyer.

11. The computer-method of claim 2, wherein a value of N is adaptively selected by the buyer.

12. The computer-method of claim 2, further comprising configuring attributes of a policy of a minimum number of bids based on a policy look up table.

13. The computer-method of claim 12, wherein the policy look up table comprises data related to fields of a buyer policy, terms of the buyer policy.

14. The computer-method of claim 1, wherein at least one of the suppliers is not registered with the buyer/supplier network.

15. The computer-method of claim 14, wherein the buyer has an enterprise resource planning (ERP) system, and the at least one supplier not registered the buyer/supplier network comprises at least one approved vendors from the ERP system of the buyer.

16. The computer-method of claim 15, further comprising the buyer/supplier network activating the at least one supplier, establishing a connection on the buyer/supplier network between the buyer and the at least one supplier.

17. The method of claim 16, wherein once the at least one supplier has been activated, the at least one supplier can push information to the buyer.

18. A buyer/supplier network, comprising:
receiving, by the buyer/supplier network, a collaboration request submitted by a buyer, thereby initiating a negotiation with one or more suppliers;
providing, by the buyer/supplier network, the collaboration request to the at least N suppliers;
receiving, by the buyer/supplier network, a proposal from at least N of the suppliers, wherein if at least N proposals are not received, then halting the collaboration; and
receiving, by the buyer/supplier network, an acceptance or a rejection to each received proposal; wherein
N is adaptively selected by the buyer.

19. A program storage device readable by a machine, tangibly embodying a program of instructions executable by the machine to perform a computer-method of dynamic collaboration of a buyer/supplier network, comprising:
providing a buyer with a catalog or non-catalog item;
receiving, by the buyer/supplier network, a collaboration request submitted by the buyer, thereby initiating a negotiation with one or more suppliers;
providing, by the buyer/supplier network, the collaboration request to the one or more suppliers;
receiving, by the buyer/supplier network, a proposal from at least one of the suppliers; and
receiving, by the buyer/supplier network, an acceptance or a rejection to each received proposal.

20. A computer-method of dynamic collaboration of a buyer/supplier network, comprising:
receiving, by a buyer/supplier network server, a collaboration request submitted through network interface from a buyer of a buyer server, thereby initiating a negotiation with N or more suppliers;
providing, by the buyer/supplier network server, the collaboration request to the N or more suppliers through the network interface;
receiving, by the buyer/supplier network server, a proposal from at least N of the suppliers, wherein if at least N proposals are not received, then the collaboration is halted; and
receiving, by the buyer/supplier network, an acceptance or a rejection to each received proposal from the buyer of the buyer server; wherein N is adaptively selected by the buyer.
